(19) United States
(12) Patent Application Publication
(10) Pub. No.: US 2021/0270728 A1
(43) Pub. Date: Sep. 2, 2021

(54) System, Apparatus and Method of Measuring Concentrations of Analytes

(71) Applicant: Atamo Pty Ltd, Bayswater (AU)

(72) Inventors: Mark Callaghan, Bayswater (AU); Stewart Snell, Bayswater (AU); Andrew Holmes, Bayswater (AU)

(21) Appl. No.: 17/252,413

(22) PCT Filed: Jun. 17, 2019
(86) PCT No.: PCT/AU2019/050624

§ 371 Date: Dec. 15, 2020

(30) Foreign Application Priority Data
Jun. 15, 2018 (AU) 2018902146

(51) Int. Cl. G01N 21/31; G01N 1/02; G01N 21/33; G01N 35/10; G01J 3/02

(52) U.S. Cl. CPC G01N 21/3103; G01N 1/02; G01N 21/33; G01N 2001/002; G01J 3/0237; G01J 3/0264; G01N 35/1095

(57) ABSTRACT

The present invention provides a system for measuring concentrations of analytes. The system comprises a sampler (17) for taking at least one sample from each of one or more surfaces. The system also comprises an analyser (19) for analysing the at least one sample to determine the concentrations of the analytes on the sampled one or more surfaces. The system further comprises a management platform (43) for receiving the measured concentrations from the analyser and communicating the concentrations of the analytes on the one or more surface, wherein the system provides the results within a suitable time.

### TECHNICAL FIELD

The present invention generally relates to a system, apparatus and method of measuring concentrations of analytes. In particular the system and method relate to measuring concentrations of analytes, such as insecticides, on any surface.

### BACKGROUND ART

As a control and preventative measure, chemicals are regularly sprayed directly on surfaces or are sprayed into the atmosphere and fall onto the surfaces. For instance insecticides are used to kill insects, such as mosquitoes, with the view of limiting the spread of insect borne diseases, such as malaria. This is critical in controlling disease propagation.

The World Health Organisation (WHO) provide guidelines in relation to the level of insecticide required to effectively treat a surface. If not enough insecticide is applied then there may not be enough coverage resulting in an ineffective treatment. On the other hand, if excessive amounts of insecticide are applied this may be harmful. Excessive concentrations of insecticide not only increase the cost, but they can cause potential harm to humans and other animals. For example, high concentrations of insecticide on floors may be harmful to infants that typically have higher proportions of skin contact with the floor and have a lower tolerance to chemicals.

An industry which requires regular spraying of insecticides is the aircraft industry. Aircraft entering many countries are required to undergo disinsection whereby the aircraft is treated with insecticide to kill stowaway insects, particularly mosquitoes. As the aircraft typically has short turnaround times, it is currently not possible to run tests to determine if the spraying has resulted in a treatment which meets WHO guidelines before the aircraft departs. It is therefore unknown whether a sufficient volume of insecticide has been sprayed, or whether too much has been sprayed.

To ensure a sufficient volume of insecticide has been sprayed the regulatory body would need to take various samples of the aircraft's surfaces once the aircraft has been sprayed and have those samples tested and analysed. In light of the short turnaround times such analysis is impractical, as well as expensive. Firstly, the taking of the sample would require suitable controls in place to ensure each sample is taken in a manner which provides consistent results from surface to surface. The samples would then need to be properly stored and taken to a laboratory for analysis. Those results would then be compared against what is considered acceptable, a report prepared and provided to the airline for action. This is time consuming with the results only available days after the aircraft has left the airport. The process also requires a skilled technician to take the samples as well as a skilled scientist to analyse those samples and provide a report.

An alternative method of determining whether a sufficient volume of insecticide has been applied is through use of a live bioassay. With this method as applied in an aircraft, live insects are positioned at various locations throughout the aircraft. The live insects are in containers which have an opening exposed to the surface upon which they are placed. The effectiveness of the insecticide is then based on the number of insects that die within a prescribed period. This method is time consuming and expensive. As a result when the method is applied to an aircraft only a very limited number of surfaces within the aircraft can be measured.

As it is currently very difficult and expensive to test whether aircraft have been adequately treated, testing is not carried out. It is therefore uncertain whether aircraft are compliant with the requisite treatment protocol.

This is not limited to aircraft. Testing for the concentration of most chemicals on a surface requires wipe sampling by a skilled technician, transfer of the samples to a laboratory, before detailed sample preparation and analysis is undertaken. The logistics and costs of the process are prohibitive which makes the concept of widespread testing in many fields uneconomic.

Another application in which it is important to measure the concentrations of analytes is in relation to the control of malaria, and in particular measuring the concentrations of insecticides on indoor surfaces of dwellings, as well as insect nets and treated fabrics. The technical difficulty and cost of testing for these purposes are similar to those for aircraft and require a similar solution.

There are various devices available for detecting the presence of a chemical, such as the device disclosed in US application 2016/0312262 to The Regents of the University of California, titled Biomimetic Virus Based Colorimetric Sensors. This application discloses a rapid means to identify the presence of a chemical(s). However, it does not analyse the sample for anything but the presence of a chemical, and is not able to provide a quantitative measure of the chemical(s) present.

Another device which is used in relation to the detection of chemicals is disclosed in Chinese Utility Model CN 204630972 to Right Biomedical Inc, titled Pesticide Detection Device. This device does not address the problems associated with taking a sample, as disclosed above. As a result the process of detecting and determining the concentration of a chemical using this device is still time consuming and costly.

The preceding discussion of the background art is intended to facilitate an understanding of the present invention only. The discussion is not an acknowledgement or admission that any of the material referred to is or was part of the common general knowledge as at the priority date of the application.

### SUMMARY OF INVENTION

It is an object of this invention to provide a system, apparatus and method of measuring concentrations of analytes which ameliorates, mitigates or overcomes, at least one disadvantage of the prior art, or which will at least provide the public with a practical choice.

In the present application the term ‘analyte’ refers to a substance or chemical constituent which is to be the subject of an analysis.

The present invention provides a system for measuring concentrations of analytes, the system comprises:
a sampler, for taking at least one sample from each of one or more surfaces;
an analyser, for analysing the at least one sample to determine the concentrations of the analytes on the sampled one or more surfaces;
a management platform for receiving the measured concentrations from the analyser and communicating the concentrations of the analytes on the one or more surface;
   wherein the system provides the results within a suitable time.

The process from initiating the sampler to take a sample to the analyser completing the analysis, recording the results and being ready to take a subsequent sample may be less than 5 minutes, but preferably less than 3 minutes.

The process of collecting a sample may take less than 10 seconds but preferably less than 5 seconds.

In contrast to the prior art, the system provides a means by which an operator can readily determine, in the field, whether the sampled surface contains sufficient concentrations of analytes, and therefore whether the treatment applied to the surface complies with application guidelines/recommendations/country specific regulations. When the analyser is analysing the sample the operator can move between sampling sites.

When the system is used to consider the treatment applied to an aircraft for instance, the operator is able to quickly determine if the treatment is sufficient or whether the aircraft needs to be retreated.

The present invention provides a system for measuring concentrations of analytes, the system includes:
a measuring apparatus comprising a sampler, for taking at least one sample from one or more surfaces, and an analyser, for analysing the at least one sample to determine the concentrations of the analytes on the sampled one or more surfaces;
a management platform for receiving the measured concentrations from the measuring apparatus and communicating the concentrations of the analytes on the one or more surface;
   wherein the system provides the results within a suitable time to allow for any additional application of chemicals.

The present invention provides a system for measuring concentrations of pyrethroid on one or more surfaces of an aircraft, the system comprises:
a sampler, for taking at least one sample from each of the one or more surfaces;
an analyser, for analysing the at least one sample to determine the concentrations of the analytes on the sampled one or more surfaces;
a management platform for receiving the measured concentrations from the analyser and communicating the concentrations of the analytes on the one or more surface to the airline;
   wherein the system can measure surface concentrations as high as 1000 mg/m².

The sampler and analyser may be provided as a measuring apparatus. The measuring apparatus may be portable.

The sampler may be releasably secured relative to the analyser.

The sampler may comprise a sampling pad for contact with the surface to be sampled.

The sampler may cause the sampling pad to move relative to the surface upon contact therewith. The movement may be rotational. The movement may be at a first speed.

In one aspect of the invention the sampler may cause the sampling pad to move upon docking with the analyser. In another aspect of the invention the analyser may cause the sampling pad to move upon docking with the analyser. The movement may be rotational. The movement may be at a second speed, where in the second speed is faster than the first speed. The second speed may be sufficient to centrifuge the sample from the sampling pad.

The sampler may include a control system to control the rotational speed for sampling and centrifuging. The control system may be in the form of a gearing system which may be engaged such that the sampling pad rotates at the first speed. When rotating at the first speed the sampling pad may be undergoing pre-wetting with a solvent before the sample is taken, sampling or rinsing. At the first speed the sampling pad may be rotated at 100-140 RPM, but preferably 115-125 RPM. The gearing system may ensure the sampling pad is rotated with sufficient torque to ensure the sampling pad rotates when in contact with the surface to be sampled.

The gearing system may be disengaged when the sampling pad is rotating at the second speed. At the second speed the sampling pad may be rotated at 5500-6500 RPM, but preferably 5750-6250 RPM. At the second speed the sampling pad is rotated to centrifuge the sample from the sampling pad.

In an alternative embodiment the control system comprises two motors and a clutch system to provide for the at least two speeds.

The sampling pad may be resilient to accommodate irregularities in the surface, and/or non-flat surfaces. This will ensure that there is consistent contact between the sampling pad and the surface such that the sampling pad is able to take a uniform sample of the surface regardless of the surface's contour.

The sampling pad may comprise a resilient pad covered by a swab material. The sampler may have a fixed skirt around the sampling pad to limit the deformation of the sampling pad during the sampling procedure. This ensures different operators apply consistent pressure on the sample pad when sampling, regardless of whether the surface is hard or soft.

In alternative arrangements the sampler may be provided with a series of sampling pads which differ in shape and/or flexibility to accommodate non-uniform surfaces.

In further alternative arrangements the sampler may incorporate a sampling pad pressure system to adjust the pressure of the sampling pad acting on the surface during the taking of a sample. The pressure may be adjusted according to the type and/or contours of the surface being sampled. The pressure system may incorporate one or more springs.

The sampling pad may take a sample from a 50 mm area of the surface. The size of the sampling pad may be selected to suit the range of concentrations expected. The size of the sampling pad may be determined by the relative rates of sample recovery from different surfaces and the range of concentrations expected. For instance, a 50 mm diameter sampling pad may be suitable for aircraft surfaces and the expected 50-1000 mg/m2 concentrations. A larger sampling pad may be relevant for those cases where the analyte is expected to be in lower concentrations and/or the recovery rates from the surface is expected to be poor.

Preferably the range of concentrations to be measured can be adjusted by changing the dimensions of the sampling pad and/or adjusting the quantities of solvent used.

The sampling pad may be changed on site once a prescribed number of samples have been taken. Preferably prescribed number of samples taken before the sampling pad is changed does not exceed 10 samples. The sampler may alert the operator once 10 samples have been taken. The sampler may fail to operate should the operator attempt to take a sample and the prescribed number of samples has already been taken.

In an alternative embodiment the sampler may be in the form of an air sampler for taking gas samples.

The sampler may be independently powered, such as by a rechargeable battery.

The measuring apparatus may incorporate a fluid distribution system, the fluid distribution system may distribute a fluid which is used to take and analyse the sample. The fluid may be a solvent suitable to dissolve the chemical from the surface.

The fluid distribution system may comprise a first reservoir for storing the fluid prior to taking the sample. The fluid distribution system may comprise a second reservoir for storing the spent fluid.

The fluid distribution system may comprise a discharge outlet for discharging the fluid onto the sampling pad of the sampler.

The fluid distribution system may comprise a collection region for collecting the sample during centrifuging of the sample pad. The collection region is in fluid communication with a spectrometer unit.

The fluid distribution system may also incorporate a verification means allowing for the collection of one or more verification samples from the measuring apparatus. These verification samples may be tested in a laboratory allowing for the verification of the accuracy of the measuring apparatus, and subsequent calibration of the measuring apparatus where required. The verification sample may also be used to identify other present chemicals not considered by the analyser and which may be affecting the results.

During operation the analyser may categorise a sample as irregular and prompt the operator to collect a verification sample. The analyser may identify a result from a sample as irregular if the result falls outside expected parameters.

In one embodiment of the invention the measuring apparatus includes a counter to count the number of samples taken. Once the counter reaches a certain number the operator will know that the first reservoir and/or the second reservoir need to be replaced. In another embodiment the measuring apparatus may comprise one or more sensors to sense the fluid levels in the first reservoir and/or the second reservoir. The sensors may be coupled to a visual and/or an audible means to alert the operator that the fluid in the first reservoir requires refilling and/or that the fluid in the second reservoir requires emptying. In another aspect of the invention the first reservoir and/or the second reservoir may be readily exchanged with a new full first reservoir and/or a new empty second reservoir, as may be required. The reservoirs may be in the form of a bladder or a rigid container.

Preferably the fluid distribution system is able to store enough fluid to carry out a required sampling protocol without having to replenish/empty the fluid. For example, when sampling an aircraft, the fluid distribution system provides sufficient fluid for a sampling protocol of 20 samples.

The analyser may be independently powered, such as by a rechargeable battery.

The analyser may house the first reservoir and the second reservoir.

The analyser may incorporate an analytical system for analysing the sample. The analysing system may provide the spectrometer unit. The spectrometer unit may comprise a detector for measuring the light energy passing thereto. The detector may be in the form of a spectrometer which may be in the form of a UV-Vis spectrometer. The spectrometer unit may cause a known wavelength of energy in the UV spectrum to be directed through the sample to a spectrometer. The wavelength of UV emitted being able to be modified according to the target chemical to be analysed.

Preferably the UV bandwidth of the spectrometer is selected based on the target analyte. The bandwidth of the analytical system may be selected prior to commencement of sampling.

The spectrometer unit may comprise a tube through which the collected sample passes. The tube may be cylindrical. The tube may be in the form of a cylindrical quartz tube. The tube can be in the form of other cross sections. The cylindrical tube negates the requirement for a separate lens.

The spectrometer unit may comprise a light source comprising two or more LED's. The minimum number of LED's required will depend on the chemical which is to be identified and analysed. As LEDs emit a narrow wavelength a number of LEDs are required. This number is relevant to the breadth of wavelength required for the analysis, and is selected to span the wavelength relevant to the absorption spectrum of the target analyte.

The LED's may be spaced apart from each other along an axis which is parallel to the central axis of the tube. The two or more LED's may be different to each other such that the variety in wavelength emitted from the combined light source provide greater uniformity.

The LED's are spaced from the tube such that the light passing through the tube is focused at the entry to the spectrometer. Preferably the spectrometer unit includes adjustment means to position the LEDs from the tube as well as to power the required number of LEDs as dictated by the chemical being analysed. In this regard the analyser can readily be adjusted to measure a different chemical.

This arrangement also allows the spectrometer unit to act in a similar manner to a flow cell, allowing samples to be taken and analysed in series.

Preferably the analyser provides a measurement of the concentration of the analyte per unit of surface area. The analyser may take into account the nature of the sampled surface when determining the concentration measurement.

The sampler may incorporate a storage means to store the data until the sampling protocol is complete, and/or until the analyser is in communication with the management platform.

The management platform may provide one or more interfaces, including an interface for interaction with the operator. The management platform may provide one or more interfaces for interaction with the operators' managers/regulatory bodies.

The management platform may be cloud based.

The management platform may comprise supervisory application and database for controlling and providing information to the measuring apparatus. The supervisory application and database may control authorisation of use of the measuring apparatus, configure the measuring apparatus, monitor alarms associated with the measuring apparatus, monitor and provide updates to the measuring apparatus, monitor the measuring apparatus for correct operation.

The management platform may control and provide information and instructions to the system including the measuring apparatus.

The management platform may be adapted to control more than one fleet of a plurality of measuring apparatus wherein each fleet is configured for different applications.

Preferably the management platform supports a duplex communication channel to the measuring apparatus. The management platform providing a means of collecting the data and monitoring the status of the sampler and analyser, and for sending control instructions to the analyser.

The management platform may be adapted to interface with more than one measuring apparatus. The system may comprise many measuring apparatus comprising a fleet. The fleet may be managed by the management platform, such that the fleet may be instructed to undertake a range of predetermined measurements and report the data to a centralised data store where it may be joined to other data relevant to the context in which the measurements were taken. The fleet may comprise a number of fleet sub-sets where each subset is configured to sample and analyse different chemicals.

The management platform may receive the analysis of the samples from the measuring apparatus and store the data in a central database.

The management platform may identify with the object to be sampled, such as for example an aircraft or a building, and provide a sampling protocol for that object. Preferably the sampling protocol determines which surfaces of the object are to be sampled. The management platform may send instructions to the measuring apparatus detailing where the sample is required to be taken.

In one aspect of the invention the management platform may send instructions to the measuring apparatus after each individual sample is taken instructing where the next sample is to be taken.

In another aspect of the invention the measuring apparatus may receive a portion of the complete sampling protocol from the management platform in one communication.

In another aspect of the invention the measuring apparatus may receive the complete sampling protocol from the management platform in one communication. This will allow the measuring apparatus to undertake the sampling protocol where a communications network is not available.

The measuring apparatus may store the recorded samples until such time as it is in communication with the management platform.

The measuring apparatus may provide means for taking, analysing and recording samples which are not provided by the sampling protocol.

The management platform may enable remote diagnosis of measuring apparatus and may provide upgrades to the measuring apparatus remotely.

The sampler may have a display means for displaying one or more of: the status of the sampler; the status of the sampling pad, or the presence of fluid on the sampling pad. The display means may be one or more of a set of LEDs, a screen, or a touch screen.

In a preferred embodiment of the invention the display means of the sampler is in the form of LEDs which provide a visual indication of the status of the sampler and the readiness of the sampling pad to take a valid sample.

The analyser may have a display means for displaying one or more of: the status of the analyser; the status of the fluid distribution system, or the sampling protocol. The display means may be one or more of a set of LEDs, a screen, or a touch screen.

In a preferred embodiment of the invention the display means of the analyser is in the form of a touch screen which provides a visual representation of the status of the sampler and analyser and allows for interaction between the operator and the sampler and analyser.

The present system provides economic surveying of the concentration of a target chemical on a variety of surfaces. It enables a large number of samples to be collected and analysed without the need to engage skilled technicians and expensive laboratory facilities.

The presenting invention provides a method of determining concentrations of an analyte on a surface. The method comprising the steps of:
providing a sampling protocol from a management platform to a measuring apparatus;
taking a sample using a sampler of the measuring apparatus from a surface according to the sampling protocol;
placing the sampler in communication with an analyser of the measuring apparatus to analyse the sampler;
providing the analysis of the sample to the management platform.

The method may further comprise the steps of:
storing the results of many analyses within the measuring apparatus in circumstances where the duplex communication channel to the management platform is unavailable;
providing for the measuring apparatus to operate independently of the management platform when required.

Prior to taking the sample a fluid distribution system of the measuring apparatus may provide fluid to the sample pad to pre-wet the pad prior to sampling. Preferably, in order to pre-wet the sample pad the sampler is docked on the analyser. If the sample pad drys out before a sample is taken an alarm may be activated.

After taking the sample the sampler is docked on the analyser and the fluid distribution system provides fluid to the sample pad during a centrifuging process which rinses the sample pad to provide a centrifuged solution. Preferably, in order to rinse the sample pad the sampler is docked on the analyser.

Preferably the fluid distribution system delivers the centrifuged solution to a sampling chamber. The sampling chamber may be incorporated in a spectrometer unit

Preferably the centrifuge solution is irradiated with UV in the desired frequency band whereby the UV passes through the sample chamber to a spectrometer of the spectrometer unit.

Once the sample is analysed the sample is discharged to waste or is diverted to a verification means. The verification means allows for the collection of one or more verification samples. The verification means comprises a verification sample holder for receiving the diverted analysed sample to be verified.

The present invention provides a system for measuring concentrations of analytes, the system includes a measuring apparatus and a management platform, the measuring apparatus comprising:
an automated surface wipe sampler, for taking at least one sample from one or more surfaces, and
an analyser for automated sample extraction and preparation, automated analysis of the sample, and recording of the resulting data coupled with contextual sample information, the data relating to the concentration of the analytes on the sampled one or more surfaces;
wherein the management platform communicates the concentrations of the analytes on the one or more surface to a cloud based application, the management platform providing further contextual information.

The present invention provides a spectrometer unit for measuring chemicals in a sample, the spectrometer unit comprises:
a tube through which the collected sample passes;
a light source which directs light to the tube;
a spectrometer having an opening through which the light passing through the tube passes.

In contrast to the prior art, the spectrometer unit does not require a separate lens array. As a result the spectrometer unit is more robust extending its application to portable devices. This also renders the spectrometer unit less expensive and smaller.

Preferably the tube is cylindrical and may be in the form of a cylindrical quartz tube. The cylindrical tube may act in a similar manner as a lens. In other embodiments the tube can take the form of other cross sections.

The light source may comprise two or more LED's. The minimum number of LED's required will depend on the absorption spectrum of the chemical which is to be identified and analysed.

The LED's may be spaced apart from each other along an axis which is parallel to the central axis of the tube. Each LED may emit a light of varying wavelength to provide a combined light source which is relatively uniform.

The LED's are spaced from the tube such that the light passing through the tube is focused at the entry to the spectrometer. Preferably the spectrometer unit includes adjustment means to position the LEDs from the tube as well as to power the required number of LEDs as dictated by the chemical being analysed. In this regard the analyser can readily be adjusted to measure a different chemical.

The present invention provides a portable sampler for taking samples from a surface, the sampler comprises:
a sampling pad for contact with the surface to be sampled;
a motor which, upon activation, causes the sampling pad to rotate;
a gearing system to control the rotational speed of the sampling pad between a sampling speed and a centrifuging speed.

The sampler may cause the sampling pad to move relative to the surface upon contact therewith.

The sampling pad may be caused to rotate prior to removing from an analyser, whereupon the sampling pad is rotated at the sampling speed and the pad is pre-wet with a solvent.

After taking a sample, the sampling pad may be caused to move upon docking with an analyser, whereupon the sampling pad is rotated at the centrifuging speed to release the sample from the sampling pad.

The gearing system may be engaged such that the sampling pad rotates at the sampling speed. When rotating at the sampling speed the sampling pad may be undergoing pre-wetting with solvent before the sample is taken, sampling or rinsing. The gearing system may ensure the sampling pad is rotated with sufficient torque to ensure the sampling pad rotates when in contact with the surface to be sampled.

The gearing system may be disengaged when the sampling pad is rotating at the centrifuging speed. At the centrifuging speed the sampling pad is rotated to centrifuge the sample from the sampling pad.

The sampling pad may be resilient to accommodate irregularities in the surface, and/or non-flat surfaces. This will ensure that there is consistent contact between the sampling pad and the surface such that the sampling pad is able to take a uniform sample of the surface regardless of the surface's contour.

The sampling pad may comprise a resilient pad covered by a swab material. The sampler may have a fixed skirt around the sampling pad to limit the deformation of the sampling pad during the sampling procedure. This ensures different operators apply consistent pressure on the sample pad when sampling, regardless of whether the surface is hard or soft.

In alternative arrangements the sampler may be provided with a series of sampling pads which differ in shape and/or flexibility to accommodate non-uniform surfaces.

In further alternative arrangements the sampler may incorporate a sampling pad pressure system to adjust the pressure of the sampling pad acting on the surface during the taking of a sample. The pressure may be adjusted according to the type and/or contours of the surface being sampled. The pressure system may incorporate one or more springs.

The sampling pad may be changed on site once a prescribed number of samples have been taken. Preferably prescribed number of samples taken before the sampling pad is changed does not exceed 10 samples. The sampler may alert the operator once 10 samples have been taken. The sampler may fail to operate should the operator attempt to take a sample and the prescribed number of samples has already been taken.

In an alternative embodiment the sampler may be in the form of an air sampler for taking gas samples.

The sampler may be independently powered, such as by a rechargeable battery.

The present invention provides a measuring apparatus for measuring concentrations of analytes, the measuring apparatus comprising a sampler as herein described and an analyser upon which the sampler is docked, wherein the analyser receives the sample form the sampler and analyses the sample, the results are then either stored within the analyser until it can later be extracted, or the results are sent to a management platform via Wi-Fi, Bluetooth or other communication means.

The present invention provides a portable analyser for analysing samples taken from a surface, the analyser comprises:
a collection chamber for receiving a sample;
a fluid distribution system for wetting a pad of a sampler when docked therewith, causing the sample to pass through a spectrometer unit to be analysed and discharging the sample into a verification means or a waste reservoir;
the spectrometer unit comprising a light source, a cylindrical tube through which the sample passes and a detector for detecting the wavelength of the light from the light source passing through the tube; and.
a communication means to communicate the results to a management system.

### BRIEF DESCRIPTION OF THE DRAWINGS

Further features of the present invention are more fully described in the following description of a non-limiting embodiment thereof. This description is included solely for the purposes of exemplifying the present invention. It should not be understood as a restriction on the broad summary, disclosure or description of the invention as set out above. The description will be made with reference to the accompanying drawings in which:

FIG. 1 is a schematic representation of a system for measuring concentrations of analytes according to an embodiment of the present invention;

FIG. 2 is a schematic representation of a measuring apparatus which forms part of the system shown in FIG. 1;

FIG. 3 is a perspective right side view of the measuring apparatus of FIG. 2 with a side cover removed to show components of the measuring apparatus, the figure showing a sampler docked with an analyser;

FIG. 4 is a perspective left side view of the measuring apparatus shown in FIG. 4;

FIG. 5 is a side view of the measuring apparatus shown in FIG. 4 without the fluid distribution system;

FIG. 6 is an upper view of the measuring apparatus of FIG. 4 showing a cross sectional view of a part of the sampler being docked relative to the analyser;

FIG. 7 is a spectrometer unit of the measuring apparatus shown in FIG. 4;

FIG. 8 is a bottom view of FIG. 7;

FIG. 9 is a front view of a fluid reservoir of the measuring apparatus as shown in FIG. 4;

FIG. 10 is a flow chart showing an embodiment of a method of the present invention; and

FIG. 11 is a schematic representation of a management platform which forms part of the system shown in FIG. 1.

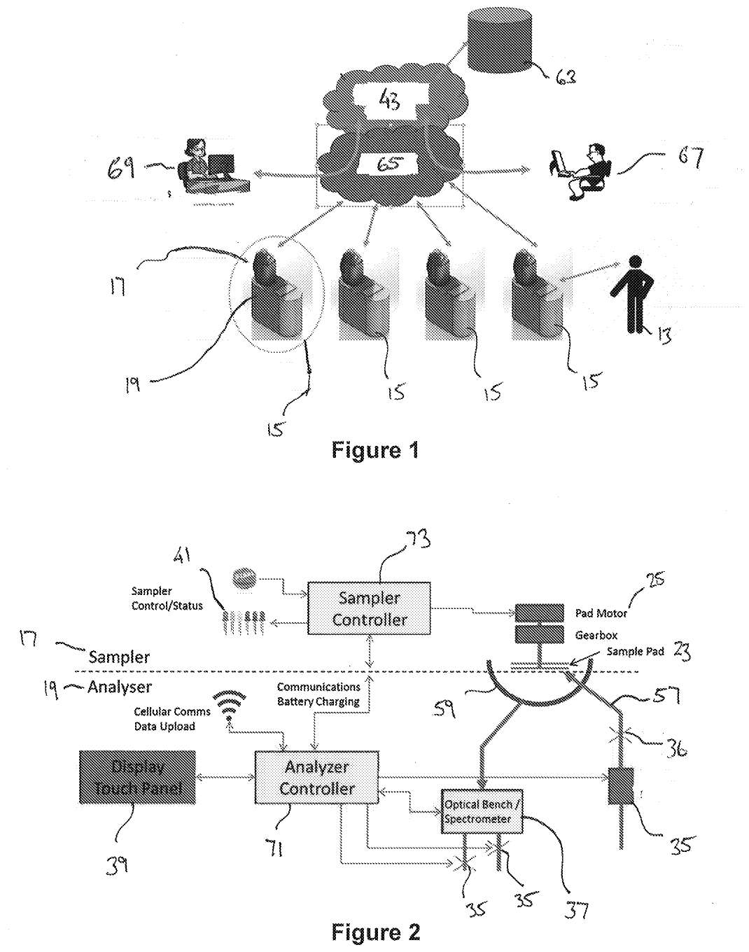

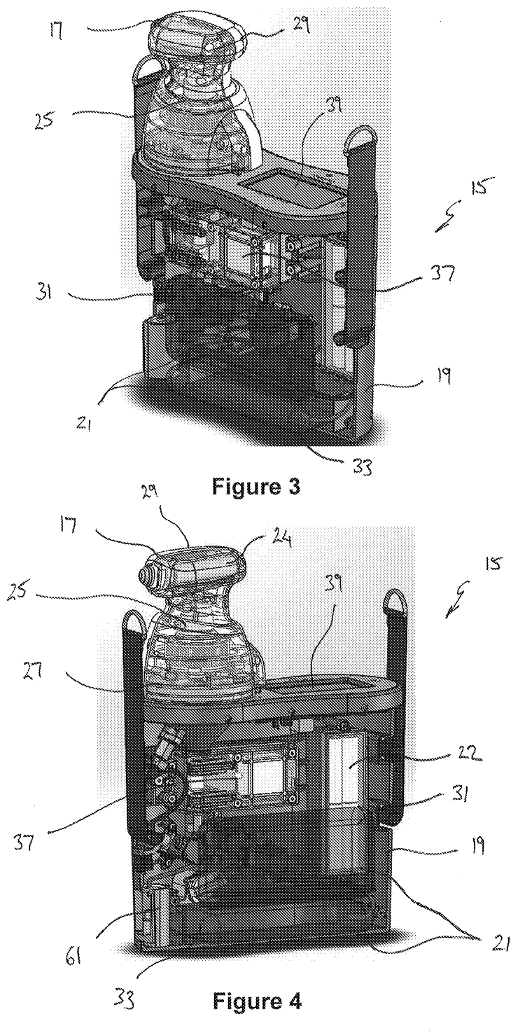

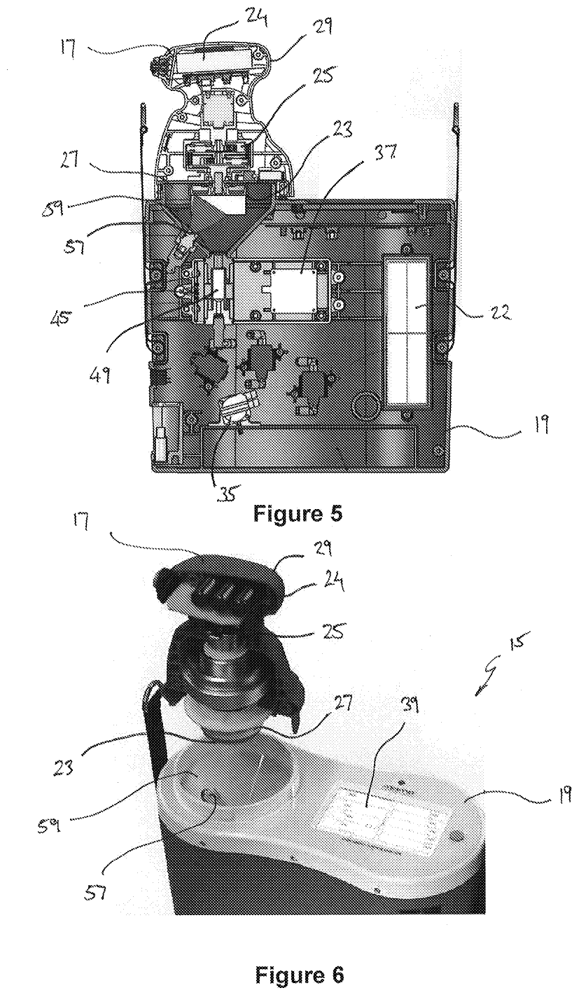

In the drawings like structures are referred to by like numerals throughout the several views. The drawings shown are not necessarily to scale, with emphasis instead generally being placed upon illustrating the principles of the present invention.

### DESCRIPTION OF EMBODIMENTS

The present invention relates to a system and method of measuring concentrations of analytes, such as insecticides, on any surface. The system is designed specifically to measure a target analyte. It enables an operator to undertake large scale surveys of the concentration of the target analyte to identify distribution of concentration on surfaces of interest. Over successive surveys, the operator is able to observe changes in concentration over time allowing for a better understanding of how chemicals can be applied, as well as assisting in identifying how long the analyte remains at an effective concentration.

The present invention is in the form of a system for determining concentrations of a chemical on a surface in a manner not currently available. Prior art systems are available for testing surfaces but these systems are deficient in that they only measure the presence of the chemical and not the concentration, require a controlled and stringent procedure when taking a sample, are required to send the samples to a laboratory for analysis, and/or the samples are required to be analysed under laboratory conditions. As a result, it is often impractical to carry out any testing of a surface, and certainly not economical to conduct mass sampling.

An embodiment of the present invention is providing and using the system to measure concentration of pyrethroid on the surface of an aircraft. This embodiment utilises a portable, automated system for measuring and recording the concentration of chemicals on surfaces. The system can be utilised for auditing the use of pesticides, such as pyrethoid, to control the spread of infectious diseases by insects. Numerous countries require aircraft to be sprayed to control stowaway insects. With the present invention these countries now have the technology to audit airline compliance with World Health Organisation guidelines and related national legislation.

In this embodiment the system is provided with a sampling protocol which includes details regarding the surfaces which are to be tested.

Referring to the figures, the system of the first embodiment comprises at least one measuring apparatus 15 and a management platform 43. The measuring apparatus 15 is a portable device which may easily be carried by an operator 13. The measuring apparatus 15 may be carried by the operator using a shoulder strap or harness (not shown).

The measuring apparatus 15 comprises a sampler 17, an analyser 19 and a fluid distribution system 21. When not sampling, the sampler 17 is releasably secured to the analyser 19. Releasably securing the sampler 17 to the analyser 19 includes engagement of the sampler 17 with the analyser 19, as well as the sampler 17 matingly docking with the sampler 17.

The measuring apparatus 15 is powered by rechargeable battery packs (22, 24) contained within the sampler 17 and the analyser 19. Recharging is accomplished with the sampler 17 docked on the analyser 19. A plug pack is connected to the analyser 19 and an electrical connection between the analyser 19 and the sampler 17 simultaneously recharges the sampler battery pack 24.

The sampler 17 is used by the operator to take a sample from a surface by wiping the surface. The sampler 17 provides a sampling pad 23 which is rotatable by a motor 25 contained within the sampler 17. The sampling pad 23 is readily replaceable and can be of the type which clicks on and off the sampler 17. The sampling pad 23 is biased outwardly by a resilient pad 27. In other embodiments the biasing may be provided by a spring. The compressible pad 27 enables good contact between the sampling pad 23 and the surface as the sample is taken. The sampler 17 incorporates a handle 29 for ease of use by the operator.

The fluid distribution system 21 circulates a fluid, such as a solvent, through the system from a first reservoir 31 to a second reservoir 33, or when required, from a first reservoir 31 to a verification sample holder 61.

The first reservoir 31 and the second reservoir 33 may be readily replaced when required. The first reservoir 31 provides unused solvent which is used during sampling, as well as to form a solution for testing. The second reservoir 33 receives spent fluid.

The fluid distribution also comprises a pump 35 to move the fluid within the fluid distribution system 21.

The fluid distribution system 21 is largely contained within the analyser 19.

The analyser 19 houses an analytical system for analysing the sample. The analytical system provides a measurement of the concentration of the analyte per unit of surface area. The analysing system is in the form of a spectrometer unit 37.

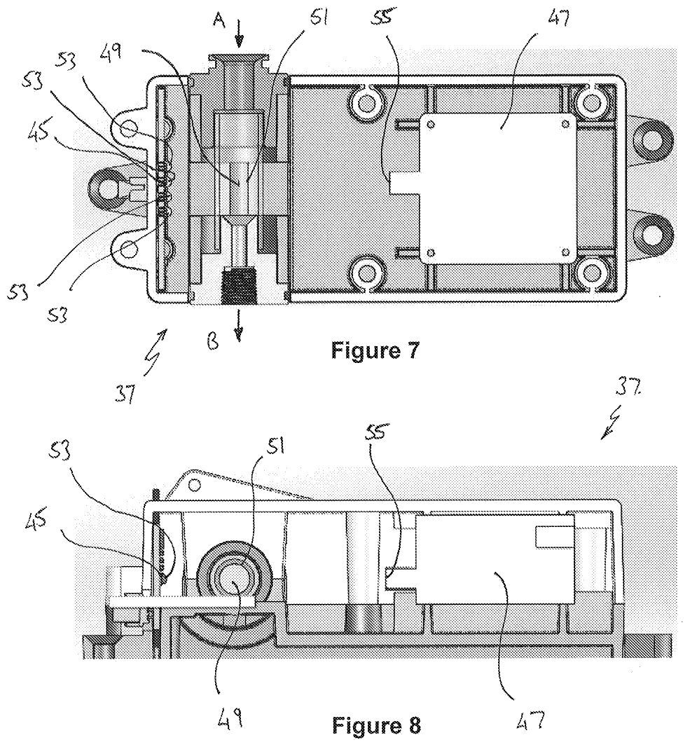

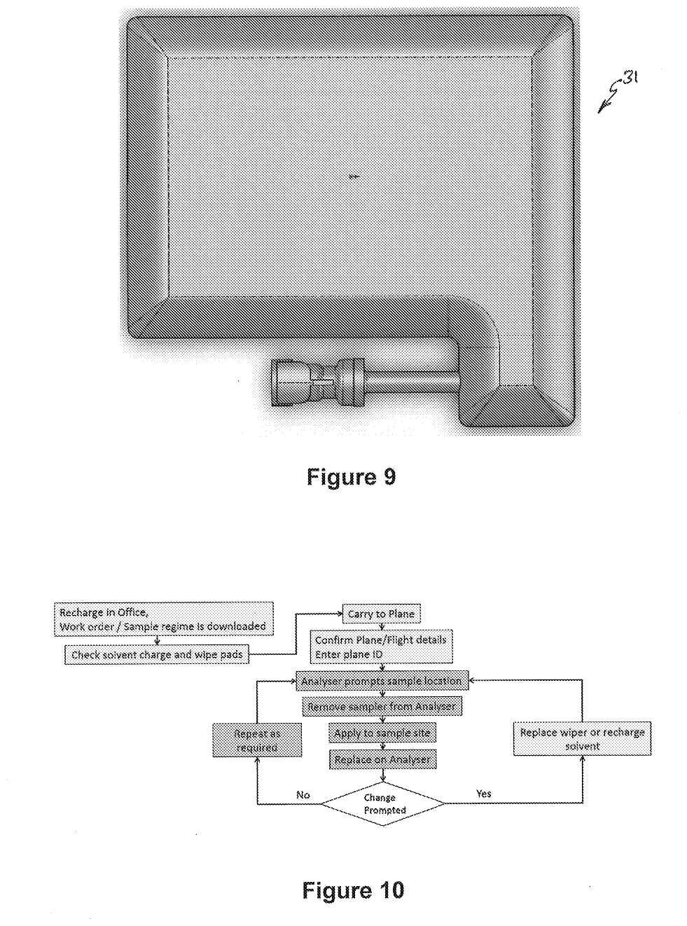

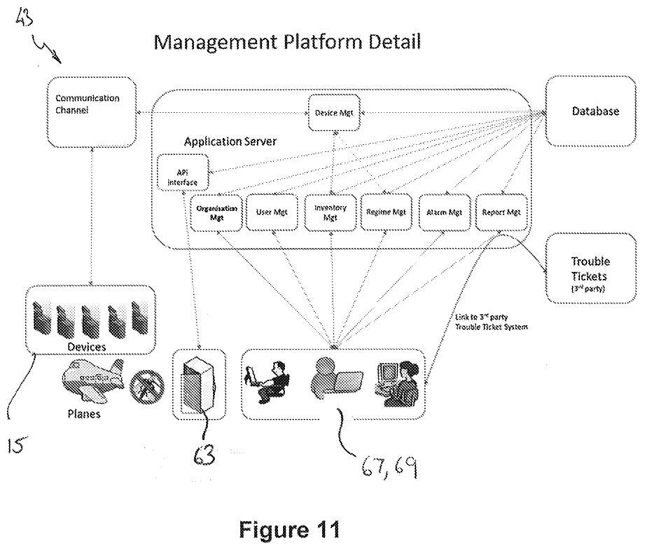

As best shown in FIGS. 7 and 8 the spectrometer unit 37 comprises a light source 45, a sampling chamber 49 and a UV-Vis spectrometer 47. The spectrometer unit comprises a cylinder quartz tube 51 through which the collected sample flows, the direction of which is denoted by arrows ‘A’ and ‘B’ shown on FIG. 7.

The light source 45 comprising four LED's 53. The LED's 53 are spaced apart from each other along an axis which is parallel to the central axis of the tube 51. The LED's 53 emit energy having varied wavelengths to each other to provide a more uniform light source. The spectrum of the LEDs is measured and the measured spectrum of the sample is adjusted as it is analysed to account for the irregularities in the LED source.

The LED's 53 are spaced from the tube 51 such that the light passing through the tube 51 is focused at the entry 55 to the spectrometer.

The analyser 19 has a touch screen 39 and is capable of independent operation during normal operation and can store analytical results. A communications system in the measuring apparatus 15 enables communications with the management platform 43.

The management platform 43 communicates with the measurement device 15, providing information to the measuring apparatus 15 as well as receiving information therefrom. This information may include contextual information relating to the surface/object being measured such as historical data (e.g. when the object was last sprayed).

The management platform 43 provides storage of analytical results and functionality to remotely configure, monitor and support the measurement device 15. The management platform 43 collects and provides information from and to a support team 67, who assist in ensuring the system functions correctly, and who facilitates upgrades and fault management. The management platform 43 also collects and provides information from and to a control center 69 which monitors the results and ensures regulations are meet, sampling protocols are appropriate, and work orders are followed. The control center 69 is also able to look and act on trends identified by the results.

Referring to FIG. 10, a step by step instruction of the system in operation as applied to an aircraft is represented. In operation the system of the present invention is adapted to take and analyse multiple samples in a manner which will allow the regulatory body to determine whether the aircraft has been sufficiently treated to meet disinsectant requirement.

Upon or before boarding an aircraft with the measuring apparatus 15, the operator inputs identification data specific to the aircraft. Once this information is received by the management platform 43, the management platform identifies the contextual information 63 associated with the specific aircraft and sends the sampling protocol for that aircraft to the measuring apparatus 15. Once this information is to hand the operator may commence the collection of samples.

In other embodiments the sampling protocol and associated identification data is sourced from a third party database. The identification data may be uploaded to a specific measuring apparatus 15 which is specific for the particular aircraft.

Upon taking a sample the operator removes the sampler 17 from the analyser and takes a sample from the surface identified by the sampling protocol. As the sample is taken the motor 25 causes the sampling pad 23 to rotate slowly with respect to the surface to retrieve the sample. The sampling pad 23 is pre-wet by the fluid distribution system 21 prior to being removed from the analyser 19.

Once the sample is taken the sampler 17 is re-docked with the analyser 19. This will allow the sample to be analysed by the analyser 19.

To retrieve the sample from the sampling pad 23 the motor 25 rotates the sampling pad 23 at a high velocity while the fluid distribution system 21 delivers fluid to the sampling pad 23 through a nozzle 57 of the fluid distribution system 21. Due to the centrifugal forces the fluid together with the sample are removed from the sampling pad 23 into a collection chamber 59. From the collection chamber the sample flows to the spectrometer unit 37 and into the sampling chamber 49. The centrifuge solution is then irradiated with UV such that the UV passes through the sampling chamber 49 to the spectrometer 47. The output of the spectrometer 47 is processed mathematically by an analyser microprocessor 71 to determine the concentration of the chemical in the sample. The mathematical algorithm is designed to identify the spectrum of the chemical in the presence of various contaminants.

The results are then stored in the analyser 19. The sampler 17 can then be removed from the analyser 19 and further samples may be taken.

Once the sample is analysed the sample is discharged to waste and stored in the second reservoir 33, or is diverted to a verification means. The verification means comprises a removable verification sample holder 61 and allows for the collection of one or more verification samples for analysis in a laboratory.

Once the sampling protocol has been completed the data can be uploaded from the measuring apparatus 15 to the management platform. This may be achieved through the internet 65 or other means apparent to those skilled in the art.

The analyser microprocessor system 71 also controls the operational sequence of the analyser and manages communications with the supervisory application. Additional functions for self-diagnosis and general status management of the analyser and sampler are under control of the analyser microprocessor system 71.

The present invention, and in particular the measuring apparatus 15 comprising the sampler 17 and the analyser 19 is a system designed to enable economic surveying of the concentration of a target chemical on a variety of surfaces. It enables a large number of samples to be collected and analysed without the need to engage skilled technicians and expensive laboratory facilities.

This embodiment of the invention is designed to survey the distribution of residual insecticide on the internal surfaces of aircraft. The insecticide may be any insecticide which is measurable using UV-Vis, such as permethrin. The measuring apparatus is required to test airline compliance to the mandatory disinsection treatment of flights. However, the scope of the present invention is not limited to this application. For instance, in other embodiments the present invention may be adapted to determine chemical concentrations on fruit and vegetables, concentration of illicit drugs on surfaces, and residual insecticides on indoor surfaces and insect repellent fabrics.

The present invention provides a means to quickly and accurately test surfaces for the concentration of residual chemicals. The present invention reduces the cost from the current hundreds of dollars per point, to the region of tens of dollars per data point. It further removes the need for skilled technicians and laboratory facilities. As a result of the present invention it is now feasible to extend testing of surfaces and develop an evidence base to inform improvement to chemical application protocols. This may lead to a reduction in the volume of chemicals used and will also lead to a more accurate means to control insects.

The present invention provides a means by which a surface may be assessed regularly in a timely and cost effective manner. After a number of surveys have been taken the operator has a set of data which can be analysed and useful conclusions drawn, such as for example how long the insecticide remains on a surface at an effective concentration. An advantage of taking regular surveys is that it allows an operator to determine whether the effectiveness of the spray is lasting as long as it should, and whether some surfaces retain the correct concentration of the analyte as long as other surfaces.

In one specific embodiment the present invention provides a system for routinely measuring the concentration of a known chemical substance on surfaces of interest. Such surfaces include interior surfaces of aircraft or other vehicles and the walls, floors and ceilings of buildings. The system comprises a service management platform based on cloud computing technology with the capability to communicate with multiple groups of portable measurement apparatus. Such communications enable the control and management of the measurement apparatus by the passing of messages that allocate tasks to the devices, configure settings in the measurement apparatus and deliver new operating software to the devices. Communications also include messages passed from the measurement apparatus to the service management platform to report readings of chemical concentration and information about device status. Each portable measurement apparatus comprises a portable sampler unit comprising an automated wipe sampler, the portable sampler unit coupled with an automated analysis system and including a touch screen display to inform operators of tasks to be performed and enable information to be passed from the operators to the service management platform. The portable measurement apparatus includes a system for wirelessly communicating with the service management platform via the internet.

The portable measurement apparatus includes an electronic controller to initiate and control the sequence of operations including pre-wetting of the sampler, instructing the sampler to spin the pad for centrifuging, controlling the fluid management system incorporating a pump 35 and a set of valves 36, controlling the UV energy source and spectrometer, analysing and storing the results of analysis and communicating with the service management platform.

The electronics controller includes algorithms to separate the information related to the target chemical from those of other substances collected from the sampled surface. In one arrangement the electronics controller is provided by the analyser microprocessor system 71. The sampler 17 also has a sampler microprocessor system 73 which may also form part of the electronics controller.

The service management platform includes functions to link information from a group of portable measurement apparatus to contextual information including records of previous chemical treatment of the surfaces of interest.

The service management platform is capable of managing multiple groups of portable measurement apparatus owned and operated by a range of owners and sampling a variety of surfaces for a variety of chemicals of interest.

Modifications and variations such as would be apparent to the skilled addressee are considered to fall within the scope of the present invention. The present invention is not to be limited in scope by any of the specific embodiments described herein. These embodiments are intended for the purpose of exemplification only. Functionally equivalent products, formulations and methods are clearly within the scope of the invention as described herein. While the present embodiment is discussed in relation to a system to measure concentration of pyrethroid on the surface of an aircraft, it can readily be applied in relation to other chemicals on surfaces of other objects. These other applications are considered to be in the scope of this specification.

Reference to positional descriptions, such as lower and upper, are to be taken in context of the embodiments depicted in the figures and are not to be taken as limiting the invention to the literal interpretation of the term but rather as would be understood by the skilled addressee.

While the invention has been shown and described with reference to certain exemplary embodiments thereof, it will be understood by those skilled in the art that various changes in form and details may be made therein without departing from the spirit and scope of the invention as defined by the appended claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise”, “comprises,” “comprising,” “including,” and “having,” or variations thereof are inclusive and therefore specify the presence of stated features, integers, steps, operations, elements, and/or components, but do not preclude the presence or addition of one or more other features, integers, steps, operations, elements, components, and/or groups thereof.

The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

1. A system for measuring concentrations of analytes, the system comprises:
a sampler, for taking at least one sample from each of one or more surfaces;
an analyser, for analysing the at least one sample to determine the concentrations of the analytes on the sampled one or more surfaces;
a management platform for receiving the measured concentrations from the analyser and communicating the concentrations of the analytes on the one or more surface;
wherein the system provides the results within a suitable time.

2. A system for measuring concentrations of analytes, the system includes:
a measuring apparatus comprising a sampler, for taking at least one sample from one or more surfaces, and an analyser, for analysing the at least one sample to determine the concentrations of the analytes on the sampled one or more surfaces;
a management platform for receiving the measured concentrations from the measuring apparatus and communicating the concentrations of the analytes on the one or more surface;
wherein the system provides the results within a suitable time to allow for any additional application of chemicals.

3. A system for measuring concentrations of pyrethroid on one or more surfaces of an aircraft, the system comprises:
a sampler, for taking at least one sample from each of the one or more surfaces;
an analyser, for analysing the at least one sample to determine the concentrations of the analytes on the sampled one or more surfaces;
a management platform for receiving the measured concentrations from the analyser and communicating the concentrations of the analytes on the one or more surface to the airline;
wherein the system can measure surface concentrations from less than 50 mg/m² to as high as 1000 mg/m².

4. The system according to claim 3 wherein the sampler and analyser are in the form of a measuring apparatus.

5. The system according to any one of the preceding claims wherein the sampler is releasably secured relative to the analyser.

6. The system according to any one of the preceding claims wherein the sampler comprises a sampling pad for contact with the surface to be sampled.

7. The system according to claim 6 wherein the sampler causes the sampling pad to move relative to the surface upon contact therewith.

8. The system according to claim wherein the 7 wherein the sampling pad is caused to rotate at least at a first speed or at a second speed, wherein the second speed is faster than the first speed, the first speed being suited to take a sample and the second speed being sufficient to centrifuge the sample from the sampling pad.

9. The system according to any one of the preceding claims wherein the sampler includes a control system to control the rotational speed and torque of the sampling pad.

10. The system according to any one of claims 6 to 9 wherein the sampling pad is resilient to accommodate irregularities in the surface, and/or non-flat surfaces.

11. The system according to claim wherein the 10 wherein the sampling pad comprises a resilient pad covered by a swab material.

12. The system according to any one of claims 6 to 11 wherein the sampler has a fixed skirt around the sampling pad to limit the deformation of the sampling pad during the sampling procedure.

13. The system according to any one of claims 6 to 9 wherein the sampler incorporates a sampling pad pressure system to adjust the pressure of the sampling pad acting on the surface during the taking of a sample.

14. The system according to any one of claims 1 to 3 wherein the sampler is in the form of an air sampler for taking gas samples.

15. The system according to any one of the preceding claims wherein the sampler is independently powered.

16. The system according to claim 2 or any one of claims 4 to 15 when dependent on claim 4 wherein the measuring apparatus incorporates a fluid distribution system, the fluid distribution system distributing a fluid which is used to take and analyse the sample.

17. The system according to claim 16 wherein the fluid is a solvent suitable to dissolve the chemical from the surface.

18. The system according to claim 16 or 17 wherein the fluid distribution system comprises a first reservoir for storing the fluid prior to taking the sample.

19. The system according to claim 16, 17 or 18 wherein the fluid distribution system comprises a second reservoir for storing the spent fluid.

20. The system according to any one of claims 16 to 19 wherein the fluid distribution system comprises a discharge outlet for discharging the fluid onto the sampling pad of the sampler.

21. The system according to any one of claims 16 to 20 wherein the fluid distribution system comprises a collection region for collecting the sample during centrifuging of the sample pad, the collection region being in fluid communication with a spectrometer unit.

22. The system according to any one of claims 16 to 21 wherein the fluid distribution system incorporates a verification means allowing for the selective collection of one or more verification samples from the measuring apparatus.

23. The system according to any one of claims 19 to 22 wherein the measuring apparatus includes a counter to count the number of samples taken, whereupon the counter reaching a certain number the operator will know that the first reservoir and/or the second reservoir need to be replaced.

24. The system according to any one of claims 19 to 22 wherein the measuring apparatus includes one or more sensors to sense the fluid levels in the first reservoir and/or the second reservoir.

25. The system according to claim 24 wherein the sensors are coupled to a visual and/or an audible means to alert the operator that the fluid in the first reservoir requires refilling and/or that the fluid in the second reservoir requires emptying.

26. The system according to any one of the preceding claims wherein the analyser is independently powered.

27. The system according to any one of claims 19 to 26 wherein the first reservoir and the second reservoir are housed in the analyser.

28. The system according to any one of the preceding claims wherein the analyser comprises an analytical system for analysing the sample.

29. The system according to claim 28 wherein the analysing system provides the spectrometer unit, the spectrometer unit comprises a spectrometer, a tube through which the collected sample passes and a light source.

30. The system according to claim 29 wherein the tube is in the form of a cylindrical quartz tube.

31. The system according to claim 29 or 30 wherein the light source comprises two or more LED's, wherein the number of LED's required is dependent on the wavelength of the absorption spectrum of the target analyte.

32. The system according to claim 31 wherein the LED's are spaced apart from each other along an axis which is parallel to the central axis of the tube.

33. The system according to claim 31 or 32 wherein the spectrometer unit includes adjustment means to adjust the position of the LEDs relative to the tube.

34. The system according to any one of the preceding claims wherein the sampler incorporates storage means to store the data associated with the sample until the sampling protocol is complete, and/or until the analyser is in communication with the management platform.

35. The system according to any one of the preceding claims wherein the management platform provides one or more interfaces, including an interface for interaction with the operator.

36. The system according to claim 2 or any one of claims 4 to 35 when dependent on claim 4 wherein the management platform comprises supervisory application and database for controlling and providing information to the measuring apparatus wherein the supervisory application and database controls authorisation of use of the measuring apparatus, configures the measuring apparatus, monitors alarms associated with the measuring apparatus, monitors and provides updates to the measuring apparatus, and monitors the measuring apparatus for correct operation.

37. The system according to claim 2 or any one of claims 4 to 36 when dependent on claim 4 wherein the management platform controls and provides information and instructions to the system including the measuring apparatus.

38. The system according to claim 2 or any one of claims 4 to 37 when dependent on claim 4 wherein the management platform controls more than one fleet of a plurality of measuring apparatus wherein each fleet is configured for different applications.

39. The system according to claim 2 or any one of claims 4 to 38 when dependent on claim 4 wherein the management platform supports a duplex communication channel to the measuring apparatus.

40. The system according to claim 2 or any one of claims 4 to 39 when dependent on claim 4 wherein the management platform interfaces with more than one measuring apparatus.

41. The system according to claim 2 or any one of claims 4 to 40 when dependent on claim 4 wherein the system comprises a fleet formed from a plurality of measuring apparatus, the fleet is managed by the management platform, such that the fleet is instructed to undertake a range of predetermined measurements and report the data to a centralised data store where it is associated with other data relevant to the context in which the measurements were taken.

42. The system according to claim 41 wherein the fleet comprises a number of fleet sub-sets where each subset is configured to sample and analyse different chemicals.

43. The system according to claim 2 or any one of claims 4 to 42 when dependent on claim 4 wherein the management platform receives the analysis of the samples from the measuring apparatus and stores the data in a central database.

44. The system according to any one of the preceding claims wherein the management platform identifies with the object to be sampled and provides a sampling protocol for that object, wherein the sampling protocol determines which surfaces of the object are to be sampled.

45. The system according to claim 2 or any one of claims 4 to 44 when dependent on claim 4 wherein the management platform sends instructions to the measuring apparatus detailing where the sample is required to be taken.

46. The system according to claim 43, 44 or 45 wherein the measuring apparatus stores the recorded samples until such time as it is in communication with the management platform.

47. The system according to claim 2 or any one of claims 4 to 46 when dependent on claim 4 wherein the management platform enables remote diagnosis of measuring apparatus and may provide upgrades to the measuring apparatus remotely.

48. The system according to any one of the preceding claims wherein the sampler has a display means for displaying one or more of: the status of the sampler; the status of the sampling pad, or the presence of fluid on the sampling pad.

49. The system according to any one of the preceding claims wherein the analyser has a display means for displaying one or more of: the status of the analyser; the status of the fluid distribution system, the status of the sampler, or the sampling protocol.

50. A method of determining concentrations of an analyte on a surface. The method comprising the steps of:
providing a sampling protocol from a management platform to a measuring apparatus;
taking a sample using a sampler of the measuring apparatus from a surface according to the sampling protocol;
placing the sampler in communication with an analyser of the measuring apparatus to analyse the sampler;
providing the analysis of the sample to the management platform.

51. The method according to claim 50 comprising the steps of:
storing the results of many analyses within the measuring apparatus in circumstances where the duplex communication channel to the management platform is unavailable;
providing for the measuring apparatus to operate independently of the management platform when required.

52. The method according to claim 50 or 51 comprising the step of providing fluid to the sample pad prior to taking the sample to pre-wet the pad prior to sampling.

53. The method according to claim 50, 51 or 52 comprising the step of providing fluid to the sample pad after taking the sample and the sampler is docked on the analyser, wherein the fluid is provided during a centrifuging process to rinse the sample pad to provide a centrifuged sample/solution.

54. The method according to claim 53 comprising the step of delivering the centrifuged solution to a sampling chamber.

55. The method according to claim 53 comprising the step of irradiating the centrifuge solution with UV in the desired frequency band whereby the UV passes through the sample chamber to a spectrometer of the spectrometer unit.

56. The method according to claim 53 comprising the step of discharging the sample, after the sample is analysed, to waste or to a verification means comprising a removable verification sample holder.

57. A system for measuring concentrations of analytes, the system includes a measuring apparatus and a management platform, the measuring apparatus comprising:
an automated surface wipe sampler, for taking at least one sample from one or more surfaces, and
an analyser for automated sample extraction and preparation, automated analysis of the sample, and recording of the resulting data coupled with contextual sample information, the data relating to the concentration of the analytes on the sampled one or more surfaces;
wherein the management platform communicates the concentrations of the analytes on the one or more surface to a cloud based application, the management platform providing further contextual information.

58. A spectrometer unit for measuring chemicals in a sample, the spectrometer unit comprises:
a tube through which the collected sample passes;
a light source which directs light to the tube;
a spectrometer having an opening through which the light passing through the tube passes.

59. The system according to claim 58 wherein the tube is in the form of a cylindrical quartz tube.

60. The system according to claim 58 or 59 wherein the light source comprises two or more LED's, wherein the number of LED's required is dependent on the wavelength of the absorption spectrum of the target analyte.

61. The system according to claim 60 wherein the LED's are spaced apart from each other along an axis which is parallel to the central axis of the tube.

62. The system according to claim 60 or 61 wherein each LED emits a light of varying wavelength to provide a combined light source which is relatively uniform.

63. The system according to claim 60, 61 or 63 wherein the LED's are spaced from the tube such that the light passing through the tube is focused at an entry to the spectrometer.

64. The system according to any one of claims 60 to 64 wherein the spectrometer unit includes adjustment means to position the LEDs relative to the tube as well as to power the required number of LEDs as dictated by the chemical being analysed.

65. A portable sampler for taking samples from a surface, the sampler comprises:
a sampling pad for contact with the surface to be sampled;
a motor which, upon activation, causes the sampling pad to rotate;
a control system to control the rotational speed of the sampling pad between a sampling speed and a centrifuging speed.

66. The system according to claim 65 wherein the sampler causes the sampling pad to move relative to the surface upon contact therewith.

67. The system according to claim 66 wherein the sampling pad is caused to rotate prior to removing from an analyser, whereupon the sampling pad is rotated at the sampling speed and the pad is pre-wet with a solvent.

68. The system according to claim 66 wherein, after taking a sample, the sampling pad is caused to move upon docking with an analyser, whereupon the sampling pad is rotated at the centrifuging speed to release the sample from the sampling pad.

69. The system according to claim 65 wherein the control system is in the form of a gearing system which can be engaged such that the sampling pad rotates at the sampling speed, the gearing system ensures the sampling pad is rotated with sufficient torque to ensure the sampling pad rotates when in contact with the surface to be sampled.

70. The system according to any one of claims 65 to 69 wherein the gearing system disengages when the sampling pad is rotating at the centrifuging speed.

71. The system according to any one of claims 65 to 70 wherein the sampling is resilient to accommodate irregularities in the surface, and/or non-flat surfaces.

72. The system according to claim 71 wherein the sampling pad comprises a resilient pad covered by a swab material.

73. The system according to any one of claims 65 to 72 wherein the sampler has a fixed skirt around the sampling pad to limit the deformation of the sampling pad during the sampling procedure.

74. The system according to any one of claims 65 to 70 wherein the sampler incorporates a sampling pad pressure system to adjust the pressure of the sampling pad acting on the surface during the taking of a sample.

75. A measuring apparatus for measuring concentrations of analytes, the measuring apparatus comprising a sampler according to any one of claims 65 to 74 and an analyser upon which the sampler is docked, wherein the analyser receives the sample from the sampler and analyses the sample, the results are then either stored within the analyser until it can later be extracted, or the results are sent to a management platform via Wi-Fi, Bluetooth or other communication means.

76. A portable analyser for analysing samples taken from a surface, the analyser comprises:
a collection chamber for receiving a sample;
a fluid distribution system for wetting a pad of a sampler when docked therewith, causing the sample to pass through a spectrometer unit to be analysed and discharging the sample into a verification means or a waste reservoir;
the spectrometer unit comprising a light source, a cylindrical tube through which the sample passes and a detector for detecting the wavelength of the light from the light source passing through the tube; and.
a communication means to communicate the results to a management system.
